(19) United States
(12) Patent Application Publication
(10) Pub. No.: US 2016/0036053 A1
(43) Pub. Date: Feb. 4, 2016

(54) Vanadium Solid-Salt Battery and Method for Manufacturing Same

(71) Applicants: Brother Kogyo Kabushiki Kaisha, Nagoya-shi (JP); Tohoku Techno Arch Co., Ltd., Sendai-shi (JP)

(72) Inventors: Shigeki Yoshida, Toyoake-shi (JP); Tomoo Yamamura, Sendai-shi (JP); Kiyoshi Sakamoto, Sendai-shi (JP); Takenori Tanno, Sendai-shi (JP)

(21) Appl. No.: 14/884,918

(22) Filed: Oct. 16, 2015

Related U.S. Application Data
(63) Continuation of application No. PCT/JP2014/056225, filed on Mar. 11, 2014.

(30) Foreign Application Priority Data
Apr. 18, 2013 (JP) 2013-087400

(51) Int. Cl. H01M 4/58; H01M 10/38; H01M 10/36

(52) U.S. Cl. CPC H01M 4/58; H01M 10/36; H01M 10/38

(57) ABSTRACT

There is provided a vanadium solid-salt battery including: a positive electrode and a negative electrode each containing vanadium of which oxidation number in an initial state is trivalent or tetravalent; and a separator which separates the positive electrode from the negative electrode and which allows hydrogen ions to pass therethrough, wherein maximum valence change in initial charging of the vanadium contained in one of the positive and negative electrodes is divalent, and maximum valence change in the initial charging of the vanadium contained in the other of the positive and negative electrodes is monovalent; and mole number of the vanadium of which maximum valence change is monovalent is not less than 1.5 times mole number of the vanadium of which maximum valence change is divalent.

### CROSS REFERENCE TO RERATED APPLICATION

This application is a Continuation Application of International Application No. PCT/JP2014/056225 which was filed on Mar. 11, 2014 claiming the conventional priority of Japanese patent Application No. 2013-087400 filed on Apr. 18, 2013.

### BACKGROUND OF THE INVENTION

1. Field of the Invention

The present disclosure relates to a vanadium battery using electrolyte containing vanadium as an active material. In particular, the present disclosure relates to a vanadium solid-salt battery (hereinafter referred to as “VSSB (Vanadium Solid-Salt Battery)”) containing a solid vanadium compound in the positive or negative electrode thereof.

2. Description of the Related Art

A secondary battery (rechargeable battery) is widely used not only for digital home electrical appliances but also for motor-powered electric automobiles and hybrid automobiles. As such a rechargeable battery, a redox-flow battery is known (U.S. Pat. No. 4,786,567). The redox-flow battery contains vanadium as an active material. The redox-flow battery uses two redox pairs producing Reduction/Oxidation (redox) reaction in an electrolyte and performs electric charging/discharging by the change in ionic valence.

The redox pairs in the redox-flow battery is exemplified by vanadium ions in +2 valence and +3 valence oxidation states (V²⁺ and V³⁺), and vanadium ions in +4 valence and +5 valence oxidation states (V⁴⁺ and V⁵⁺). An aspect of the redox-flow battery is exemplified by a liquid circulation-type redox-flow battery. In the liquid circulation-type redox-flow battery, a sulfuric acid solution of vanadium stored in a tank is supplied to a liquid circulation-type cell wherein the electric charging/discharging is performed. The liquid circulation-type redox-flow battery is used in the field of large electric power storage.

The liquid circulation-type redox-flow battery includes a tank for an electrolyte containing a positive electrode active material and a tank for an electrolyte containing a negative electrode active material, two stacks performing the electric charging/discharging, and a pump which feeds the electrolyte for positive side or the electrolyte for negative side to each of the stacks. Each of the electrolytes is fed from the tank to one of the stacks and is circulated between the tank and one of the stacks. Each of the stacks has such a configuration that an ion-exchange membrane is sandwiched between the positive and negative electrodes. In the redox-flow battery, the following reactions occur in the positive and negative electrodes, respectively.

Positive electrode:

VO²⁺(aq)+H₂O [symbol] VO₂⁺(aq)+e⁻+2H⁺ (1)

Negative electrode:

V³⁺(aq)+e⁻ [symbol] V²⁺(aq) (2)

In the formulae (1) and (2), the symbol “ [symbol] ” represents chemical equilibrium. In the present specification, the term “chemical equilibrium” means a state in which, in reversible reaction, an amount of change in a product coincides with an amount of change in a starting material. Further, the suffix “(aq)” added to the ions indicates that the ions exist in the solution. The symbol “ [symbol] ” and the suffix “(aq)” are used in the same meanings as described above, in any other formulae in the present specification.

In order to obtain a light-weight and compact redox battery having a high output performance, there is proposed a liquid static-type redox battery in which the electrolyte is not circulated (Japanese Patent Application Laid-open No. 2002-216833). This liquid static-type redox battery does not have any tank of electrolyte. Rather, the liquid static-type redox battery has a tank of electrolyte for positive side and a tank of electrolyte for negative side. The liquid static-type redox battery has a configuration wherein each of the tanks for positive side and negative side is filled with an electrolyte containing vanadium ions as an active material and a conductive material such as powder of carbon, etc.

Other than those described above, there is proposed a vanadium solid-salt battery (United States Patent Application Publication No. 2012/301787). The vanadium solid-salt battery includes an electrode supporting a deposited substance thereon, the deposited substance containing vanadium ion or positive ion including vanadium.

The vanadium solid-salt battery disclosed in United States Patent Application Publication No. 2012/301787 is quite useful in that the battery is light-weight and compact, and satisfies the demand for high energy density. Such a vanadium solid-salt battery is desired to have a high battery capacity in order to improve the battery performance.

An object of the present disclosure is to provide a vanadium solid-salt battery with high battery capacity and to provide a method for producing the vanadium solid-salt battery.

### SUMMARY OF THE INVENTION

According to a first aspect of the present disclosure, there is provided a vanadium solid-salt battery including:

a positive electrode and a negative electrode each containing vanadium of which oxidation number in an initial state is trivalent or tetravalent; and

a separator which separates the positive electrode from the negative electrode and which allows hydrogen ions to pass therethrough,

wherein maximum valence change in initial charging of the vanadium contained in one of the positive and negative electrodes is divalent, and maximum valence change in the initial charging of the vanadium contained in the other of the positive and negative electrodes is monovalent; and

mole number of the vanadium of which maximum valence change is monovalent is not less than 1.5 times mole number of the vanadium of which maximum valence change is divalent.

According to a second aspect of the present disclosure, there is provided a method for producing a vanadium solid-salt battery including:

supporting a first active material on one of electrodes constructing a positive electrode and a negative electrode, the first active material containing vanadium of which oxidation number in an initial state is trivalent or tetravalent and of which maximum valence change in initial charging is monovalent, and

supporting a second active material on the other of the electrodes constructing the positive electrode and the negative electrode, the second active material containing vanadium of which oxidation number in an initial state is trivalent or tetravalent and of which maximum valence change in the initial charging is divalent, wherein

mole number of the first active material is not less than 1.5 times mole number of the second active material.

### BRIEF DESCRIPTION OF DRAWINGS

FIG. 1 is a schematic view depicting the configuration of a vanadium solid-salt battery.

FIG. 2 is a flowchart depicting a method for producing vanadium solid-salt battery according to an embodiment.

FIG. 3 is a flowchart depicting a method for producing vanadium solid-salt battery according to another embodiment.

FIGS. 4A to AD depict time-voltage curve in a charge-discharge test conducted for vanadium solid-salt batteries of Examples 1 to 3 and Comparative Example 1, wherein FIG. 4A depicts the time-voltage curve regarding Comparative Example 1 (V Mole number of positive electrode: V Mole number of negative electrode=1:1), FIG. 4B depicts the time-voltage curve regarding Example 1 (V Mole number of positive electrode: V Mole number of negative electrode=1.5:1), FIG. 4C depicts the time-voltage curve regarding Example 2 (V Mole number of positive electrode: V Mole number of negative electrode=2:1), and FIG. 4D depicts the time-voltage curve regarding Example 3 (V Mole number of positive electrode: V Mole number of negative electrode=2.5:1).

FIG. 5 depicts a relationship between number of charging/discharging cycles (n) and battery capacity (mAh) in the charge-discharge test conducted for Examples 1 to 3 and Comparative Example 1.

FIG. 6 depicts a relationship between the number of charging/discharging cycles (n) and amount of electric power (mWh) in the charge-discharge test conducted for Examples 1 to 3 and Comparative Example 1.

FIGS. 7A to 7D depict time-voltage curve in a charge-discharge test conducted for vanadium solid-salt batteries of Examples 4 to 6 and Comparative Example 2, wherein FIG. 7A depicts the time-voltage curve regarding Comparative Example 2 (V Mole number of positive electrode: V Mole number of negative electrode=1:1), FIG. 7B depicts the time-voltage curve regarding Example 4 (V Mole number of positive electrode: V Mole number of negative electrode=1:1.5), FIG. 7C depicts the time-voltage curve regarding Example 5 (V Mole number of positive electrode: V Mole number of negative electrode=1:2), and FIG. 7D depicts the time-voltage curve regarding Example 6 (V Mole number of positive electrode: V Mole number of negative electrode=1:2.5).

FIG. 8 depicts a relationship between number of charging/discharging cycles (n) and battery capacity (mAh) in the charge-discharge test conducted for Examples 4 to 6 and Comparative Example 2.

FIG. 9 depicts a relationship between the number of charging/discharging cycles (n) and amount of electric power (mWh) in the charge-discharge test conducted for Examples 4 to 6 and Comparative Example 2.

### DESCRIPTION OF PREFERD EMBODIMENTS

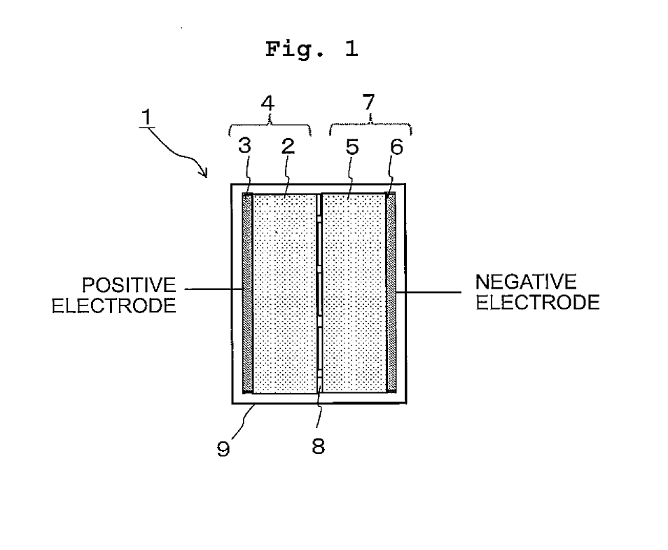

Firstly, schematic configuration of a vanadium solid-salt battery will be explained with reference to FIG. 1. FIG. 1 depicts the schematic configuration of the vanadium solid-salt battery.

As depicted in FIG. 1, a vanadium solid-salt battery 1 has a positive electrode (positive side) 4, a first electrode 2, and a first current collector 3 which extracts electrons. The vanadium solid-salt battery 1 further has a negative electrode (negative side) 7, a second electrode 5 and a second current collector 6. Furthermore, the vanadium solid-salt battery 1 includes a separator (separation membrane) 8 which separates the positive electrode 4 from the negative electrode 7 and which allows hydrogen ions to pass therethrough. The vanadium solid-salt battery 1 is configured as a single stack by stacking the first current collector 3, the first electrode 2, the separator 8, the second electrode 5 and the second current collector 6 in this order. The vanadium solid-salt battery 1 depicted in FIG. 1 has such a configuration that the single stack is inserted into a cell 9. Further, the vanadium solid-salt battery 1 has such a configuration that electric wires are connected to the first and second current collectors 3 and 6, respectively.

The positive and negative electrodes contain an active material. The active material includes vanadium. Vanadium is an element which can be in different oxidation states of several kinds including divalence, trivalence, tetravalence and pentavalence. Further, vanadium is an element having an electric potential difference useful for battery.

At first, a general vanadium solid-salt battery will be explained. The general vanadium solid-salt battery contains, in the positive electrode, vanadium of which oxidation number in the initial state is tetravalent. Further, the general vanadium solid-salt battery contains, in the negative electrode, vanadium of which oxidation number in the initial state is trivalent. This vanadium solid-salt battery exhibits the following reactions.

Positive electrode:

VOX₂.nH₂O(s) [symbol] VO₂X.(n-1)H₂O(s)+HX+H⁺+e⁻ (3)

Negative electrode:

VX₃.nH₂O(s)+e⁻ [symbol] VX₂.nH₂O(s)+HX (4)

In the reactions indicated in the present specification, “X” represents a monovalent anion. Note that, however, even in a case that “X” is a m-valent anion, coupling coefficient (1/m) may be considered. Further, in the reactions indicated in the present specification, “n” indicated that “n” can take various values.

The standard electrode potential of VO²⁺/VO₂⁺ of the positive electrode active material exhibiting the reaction of the formula (3) is 1.0V. Further, the standard electrode potential of VO³⁺/VO²⁺ of the negative electrode active material exhibiting the reaction of the formula (4) is −0.255V. Accordingly, the standard electromotive force of the vanadium solid-salt battery exhibiting the reactions of the formulae (3) and (4) is 1.255V.

As indicated by the following formulae (i) to (iii), the theoretical capacity of a battery can be derived from an amount of substance of electrode active material. In some cases, the vanadium solid-salt battery uses vanadium oxide sulfate (IV) (VOSO₄.nH₂O) in the positive electrode, and uses vanadium sulfate (III) (V₂(SO₄)₃.nH₂O) in the negative electrode. The theoretical capacity of this vanadium solid-salt battery can be derived from the following formulae (i) to (iii). The maximum change in valence (maximum valence change) of vanadium contained in the positive electrode is monovalent. The maximum valence change of vanadium contained in the negative electrode is monovalent. The theoretical capacity of battery is a numerical value of a smaller one of the theoretical capacity of the positive electrode and the theoretical capacity of the negative electrode.

Theoretical capacity of positive electrode: the amount of substance of active material in the positive electrode×Faraday constant÷3600 (i)

Theoretical capacity of negative electrode: the amount of substance of active material in the negative electrode×Faraday constant÷3600 (ii)

Theoretical capacity of battery: smaller one of the theoretical capacity of the positive electrode and the theoretical capacity of the negative electrode (iii)

Next, a vanadium solid-salt battery of the present disclosure will be explained. The vanadium solid-salt battery of the present disclosure contains, in each of the positive and negative electrodes, vanadium of which oxidation number in the initial state is either one of trivalent and tetravalent. A compound containing the trivalent vanadium is exemplified by vanadium sulfate (III) (V₂(SO₄)₃.nH₂O). A compound containing the tetravalent vanadium is exemplified by vanadium oxide sulfate (IV) (VOSO₄.nH₂O).

In the vanadium solid-salt battery of the present disclosure, the maximum valence change of the vanadium contained in one of the positive and negative electrodes is divalent; further, the maximum valence change of the vanadium contained in the other of the positive and negative electrodes is monovalent. The vanadium solid-salt battery contains, in any one of the positive and negative electrodes, the vanadium of which maximum valence change is divalent, so as to increase the standard electrode potential, thereby making it to possible to increase the standard electromotive force of the vanadium solid-salt battery. Further, the vanadium solid-salt battery of the present disclosure is capable of increasing the battery capacity. Furthermore, the vanadium solid-salt battery of the present disclosure is capable of increasing the energy density.

The vanadium solid-salt battery of the present disclosure contains vanadium of which oxidation number in the initial state is tetravalent in each of the positive and negative electrodes, as an embodiment.

The positive and negative electrodes each containing the vanadium of which oxidation number in the initial state is tetravalent exhibit the following reactions.

Positive electrode:

VOX₂.nH₂O(s) [symbol] VO₂X.(n-1)H₂O(s)+HX+H⁺+e ⁻ (5)

Negative electrode:

VOX₂.nH₂O(s)+HX+H⁺+e⁻ [symbol] VX₃.nH₂O(s)+H₂O (6)

VX₃.nH₂O(s)+H⁺+e⁻ [symbol] VX₂.nH₂O(s)+HX (7)

The vanadium solid-salt battery of the present disclosure contains vanadium oxide sulfate (IV) (VOSO₄.nH₂O) in both of the positive and negative electrodes. The vanadium solid-salt battery of the present disclosure exhibits the reactions of the formulae (5) to (7). In this vanadium solid-salt battery, the maximum valence change of vanadium contained in the positive electrode is monovalent, and the maximum valence change of vanadium contained in the negative electrode is divalent. The theoretical capacity of the battery is a numerical value of a smaller one of the theoretical capacity of the positive electrode and the theoretical capacity of the negative electrode. In a case that the mole number of vanadium in the positive electrode is 1.5 and that the mole number of vanadium in the negative electrode is 1 (V Mole number of positive electrode: V Mole number of negative electrode=1.5:1), the theoretical capacity of the battery is the theoretical capacity of the negative electrode.

Further, in the vanadium solid-salt battery of the present disclosure, the mole number (amount of substance) of the vanadium of which maximum valence change is monovalent is not less than 1.5 times the mole number (amount of substance) of the vanadium of which maximum valence change is divalent. The ratio between the mole number of the vanadium of which maximum valence change is monovalent and the mole number of the vanadium of which maximum valence change is divalent (Monovalent V Mole number : Divalent V Mole number) is preferably in a range of 1.5:1 to 2.5:1. The vanadium solid-salt battery of the present disclosure is capable of changing the valence of vanadium contained in the negative electrode maximally to divalence in the initial charging. Accordingly, the vanadium solid-salt battery of the present disclosure is capable of increasing the standard electrode potential, thereby making it possible to increase the theoretical battery capacity. The vanadium solid-salt battery of the present disclosure is also capable of increasing an actual battery capacity as well.

Next, the reactions occurring in the positive and negative electrodes will be explained. Each of the positive and negative electrodes contains, in the initial state, vanadium oxide sulfate (IV) (VOSO₄.nH₂O).

At first, the reactions occurring in the positive electrode will be explained.

Positive electrode:

VOSO₄.nH₂O(s) [symbol] VOSO₄.nH₂O(aq) [symbol] VOSO₄(aq)+nH₂O(aq) (8)

(VO₂)₂SO₄.nH₂O(s) [symbol] (VO₂)₂SO₄.nH₂O(aq) [symbol] (VO₂)₂SO₄(aq)+nH₂O(aq) (9)

VO²⁺(aq)+VO₂⁺(aq) [symbol] V₂O₃³⁺(aq) (10)

VOSO₄(aq) [symbol] VO²⁺(aq)+SO₄²⁻(aq) (11)

(VO₂)₂SO₄(aq) [symbol] 2VO₂⁺(aq)+SO₄²⁻(aq) (11-1)

VO²⁺(aq)+H₂O [symbol] VO₂⁺(aq)+2H⁺ (12)

Next, the reactions occurring in the negative electrode will be explained.

Negative electrode:

VOSO₄.nH₂O(s) [symbol] VOSO₄.nH₂O(aq)VOSO₄(aq)+nH₂O(aq) (13)

VOSO₄(aq) [symbol] VO²⁺(aq)+SO₄²⁻(aq) (13-1)

VO²⁺(aq)+2H⁺+e⁻ [symbol] V³⁺(aq)+H₂O (14)

V₂(SO₄)₃.nH₂O(s) [symbol] V₂(SO₄)₃.nH₂O(aq) [symbol] V₂(SO₄)₃(aq)+nH₂O(aq) (15)

VSO₄.nH₂O(s) [symbol] VSO₄.nH₂O(aq) [symbol] VSO₄(aq)+nH₂O(aq) (16)

V₂(SO₄)₃(aq) [symbol] 2V³⁺(aq)+3SO₄²⁻ (17)

V³⁺(aq)+e⁻ [symbol] V²⁺(aq) (17-1)

V²⁺(aq)₊SO₄²⁻ [symbol] VSO₄(aq) (17-2)

Next, the vanadium solid-salt battery of the present disclosure contains vanadium of which oxidation number in the initial state is trivalent in each of the positive and negative electrodes, as another embodiment.

The positive and negative electrodes each containing the vanadium of which oxidation number in the initial state is trivalent exhibit the following reactions.

Positive electrode:

VX₃.nH₂O(s) [symbol] VOX₂.(n-1)H₂O(s)+HX+H⁺+e⁻ 18)

VOX₂.(n-1)H₂O(s) [symbol] VO₂X.(n-2)H₂O(s)+HX+H⁺+e⁻ (19)

Negative electrode:

VX₃.nH₂O(s)+H⁺+e⁻ [symbol] VX₂.nH₂O(s)+HX (20)

The vanadium solid-salt battery of the present disclosure contains vanadium sulfate (III) (V₂(SO₄)₃.nH₂O) in both of the positive and negative electrodes. The vanadium solid-salt battery of the present disclosure exhibits the reactions of the formulae (18) to (20). In this vanadium solid-salt battery, the maximum valence change of the vanadium contained in the positive electrode is divalent, and the maximum valence change of the vanadium contained in the negative electrode is monovalent. The theoretical capacity of battery is a numerical value of a smaller one of the theoretical capacity of the positive electrode and the theoretical capacity of the negative electrode. In a case that the mole number of vanadium in the positive electrode is 1 and that the mole number of vanadium in the negative electrode is 1.5 (V Mole number of positive electrode: V Mole number of negative electrode=1:1.5), the theoretical capacity of the battery is the theoretical capacity of the positive electrode.

Further, in the vanadium solid-salt battery of the present disclosure, the mole number of the vanadium of which maximum valence change is monovalent is not less than 1.5 times the mole number of the vanadium of which maximum valence change is divalent. The ratio between the mole number of the vanadium of which maximum valence change is monovalent and the mole number of the vanadium of which maximum valence change is divalent (Monovalent V Mole number : Divalent V Mole number) is preferably in a range of 1.5:1 to 2.5:1. The vanadium solid-salt battery of the present disclosure is capable of changing the valence of vanadium contained in the positive electrode maximally to divalence in the initial charging. Accordingly, the vanadium solid-salt battery of the present disclosure is capable of increasing the standard electrode potential, thereby making it possible to increase the theoretical battery capacity. The vanadium solid-salt battery of the present disclosure is also capable of increasing an actual battery capacity as well.

Next, the reactions occurring in the positive and negative electrodes will be explained. Each of the positive and negative electrodes contains, in the initial state, vanadium sulfate (III) (V₂(SO₄)₃.nH₂O).

At first, the reactions occurring in the positive electrode will be explained.

Positive electrode:

V₂(SO₄)₃.nH₂O(s) [symbol] V₂(SO₄)₃^{.nH}₂O(aq) [symbol] V₂(SO₄)₃(aq)+nH₂O(aq) (21)

V³⁺(aq)+H₂O [symbol] VO²⁺(aq)+2H⁺+e⁻ (22)

In addition to the reactions of the formulae (21) and (22), the reactions of formulae (8) to (12) also occur in the positive electrode.

Further, the reactions of formulae (15) to (17-2) occur in the negative electrode.

Next, materials constructing the vanadium solid-salt battery of the present disclosure will be explained.

<Electrode>

The electrode may use a carbon felt composed of carbon fiber, a carbon sheet composed of carbon fiber, activated carbon, glassy carbon, etc. An electrode for the negative side or an electrode for the positive side may use an electrode composed of a same material, or may use an electrode including a plurality of kinds of materials. The electrode for the negative side preferably uses an electrode including at least one material selected from the group consisting of: a carbon felt, and activated carbon. The electrode for the positive side preferably uses an electrode including at least one material selected from the group consisting of: a carbon felt, a carbon sheet, activated carbon and glassy carbon. The activated carbon used as the electrode is preferably particulate active carbon of which average particle diameter is in a range of 5 μm to 20 μm. Here, the term “average particle diameter” means a median diameter on a volume basis measured by a laser diffraction/scattering grain size distribution measurement.

In a case of using a carbon felt as the electrode, the carbon felt is preferably composed of carbon fiber of which diameter is in a range of 10 μm to 20 μm. Further, the basis weight of carbon felt is preferably in a range of 200 g/m² to 500 g/m², more preferably in a range of 250 g/m² to 450 g/m², particularly preferably in a range of 300 g/m² to 400 g/m².

<Current Collector>

As the current collector, it is possible to use a current collector formed of a conductive rubber, a current collector formed of a graphite sheet, a current collector formed by coating or contacting the conductive rubber on a metallic foil, or a current collector formed by coating or contacting the graphite sheet on a metallic foil. It is particularly preferable that a current collector obtained by coating or contacting the conductive rubber on the metallic foil, or a current collector formed by coating or contacting the graphite sheet on the metallic foil is used as the current collector. The current collector obtained by coating or contacting the conductive rubber on the metallic foil and the current collector formed by coating or contacting the graphite sheet on the metallic foil are capable of lowering the resistance as compared with a case of using a current collector in which any metallic foil is not used. The conductive rubber is preferably sheet-shaped. The thickness of the conductive rubber or the thickness of the graphite sheet is not particularly limited. The thickness of the conductive rubber or the thickness of the graphite sheet is preferably in a range of 10 μm to 150 μm, more preferably in a range of 20 μm to 120 μm, further more preferably in a range of 30 μm to 100 μm. Further, the metal constructing the metallic foil is exemplified by copper, aluminum, silver, gold, nickel, stainless steel (SUS303, SUS316L, etc.), and the like which have small resistance. The metallic foil is preferably copper foil or aluminum foil, since the copper foil or the aluminum foil is not expensive. Furthermore, the thickness of the metallic foil is preferably in a range of 10μm to 150 μm, more preferably in a range of 20 μm to 120 μm, further more preferably in a range of 30 μm to 100 μm.

<Separator>

The vanadium solid-salt battery includes a separator (separation membrane) which separates the positive electrode from the negative electrode and which allows hydrogen ions (protons) to pass therethrough. It is allowable to use, as the separator, any separator provided that the separator allows the hydrogen ions (proton) to pass therethrough. As the separator, it is allowable to use a porous membrane, a nonwoven fabric, or an ion-exchange membrane which selectively allows the hydrogen ions to pass therethrough. The porous membrane is exemplified, for example, by a microporous film (membrane) formed of polyethylene (manufactured by Asahi Kasei Corporation), etc. Further, the nonwoven fabric is exemplified, for example, by “NanoBase (trade name)” (manufactured by Mitsubishi Paper Mills Limited). Furthermore, the ion-exchange membrane is exemplified, for example, by “SELEMION (trade name) APS” (manufactured by Asahi Glass Co., Ltd.), and the like.

<Active Material>

The active material is preferably a deposited substance deposited from a mixture obtained by adding an aqueous solution of sulfuric acid to a vanadium compound. The vanadium compound is exemplified by vanadium oxide sulfate (IV) (VOSO₄.nH₂O). Alternatively, the vanadium compound is exemplified by vanadium sulfate (III) (V₂(SO₄)₃.nH₂O). Here, “n” represents 0 (zero) or an integer in a range of 1 to 6.

As the aqueous solution of sulfuric acid, it is preferably to use, for example, dilute sulfuric acid in which the concentration of the sulfuric acid is less than 90% by mass. The amount of the aqueous solution of sulfuric acid is preferably made to be an exact or proper amount at which the battery may be in the state of charge (SOC) of 0% to 100%. The amount of the aqueous solution of sulfuric acid is, for example, 70mL of 2M (mol/L) sulfuric acid with respect to 100g of the vanadium compound.

Further, the aqueous solution of sulfuric acid containing the vanadium compound preferably has hardness or viscosity to such an extent for allowing the aqueous solution to adhere to the electrode. The aqueous solution of sulfuric acid containing the vanadium compound may be in a solid state, or in a semi-solid state. Here, the term “semi-solid state” includes a state of slurry obtained by adding, for example, an aqueous solution of sulfuric acid to the vanadium compound, and a state of gel obtained by adding silica to the vanadium compound.

In the present disclosure, the vanadium solid-salt battery may contain the aqueous solution of sulfuric acid, as a small amount of electrolyte. The phrase “small amount of electrolyte” means an exact or proper amount at which the battery may be in the SOC of 0% to 100%. The exact or proper amount of the electrolyte at which the battery may be in the SOC of 0% to 100% is, for example, 70 mL of 2M (mol/L) sulfuric acid with respect to 100 g of the vanadium compound.

<Other Materials>

In the present disclosure, the vanadium solid-salt battery may use carbon fiber as electric wires for connection with the current collectors. Further, the vanadium solid-salt battery of the present disclosure may use a cell which is formed of, for example, a synthetic resin and which accommodates a stack constructed of two electrodes, two current collectors and a separator.

[Method for Producing Vanadium Solid-Salt Battery]

Next, a method for producing the vanadium solid-salt battery of the present disclosure will be explained.

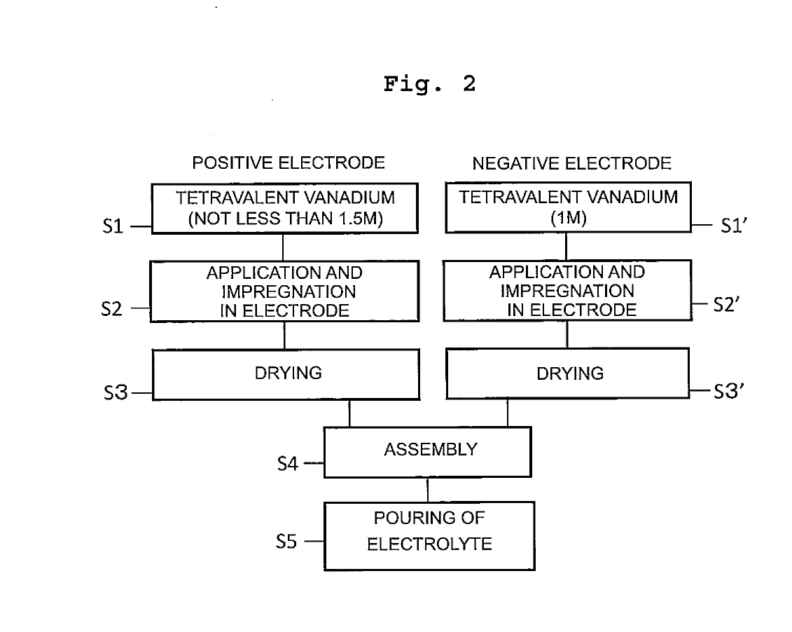

FIG. 2 is a flowchart depicting an embodiment of the method for producing vanadium solid-salt battery. Steps for producing the vanadium solid-salt battery includes steps S1 to S5. Steps S1 to S3 are steps for allowing an electrode constructing the positive electrode to support an active material containing vanadium of which oxidation number in the initial state is tetravalent. Steps S1′ to S3′ are steps for allowing an electrode constructing the negative electrode to support an active material containing vanadium of which oxidation number in the initial state is tetravalent. Steps S4 and S5 are steps for assembling constitutive parts and components to thereby obtain a battery. Steps S1 to S3 and Steps S1 ′ to S3′ contain same steps. Note that, however, Steps S1 to S3 and Steps S1′ to S3′ are different in the volume (mL) of the solution which contains the vanadium having tetravalent oxidation number and which is impregnated in the electrodes.

<Step S1 and Step S1′>

Each of Step S1 and Step S1′ is a step of preparing a solution containing the vanadium of which oxidation number is tetravalent. Here, the vanadium of which oxidation number is tetravalent can be exemplified by a vanadium ion (V⁴⁺) or a cation (VO²⁺) including vanadium. The phrase “solution containing (the) vanadium of which oxidation number is tetravalent” or “solution containing (the) vanadium having (the) tetravalent oxidation number” can be exemplified, for example, by an aqueous solution of vanadium oxide sulfate (IV) (VOSO₄.nH₂O).

The concentration of the aqueous solution of vanadium oxide sulfate (IV) is designed depending on the change in valence of the vanadium in each of the positive and negative electrodes. The concentration of the aqueous solution of vanadium oxide sulfate (IV) is preferably in a range of 1M (mol/L) to 3M (mol/L). The concentration of the aqueous solution of vanadium oxide sulfate (IV) is more preferably in a range of 1.5M (mol/L) to 2.5M (mol/L). The concentration of the vanadium compound in the aqueous solution is changed depending on the kind of the electrode, the thickness of the electrode, etc.

<Step S2 and Step S2′>

Steps S2 and S2′ are steps of impregnating the electrodes with the solution containing the vanadium of which oxidation number is tetravalent, or of applying the solution to the electrodes.

The vanadium of which oxidation number is tetravalent is an active material of the electrode. In a case of using the vanadium of which oxidation number is tetravalent as the active material, the active material is supported on (by) the electrodes in such a manner that the maximum valence change in an initial charging of the vanadium, which is contained the active material supported on the electrode for the positive side, is monovalent; and that the maximum valence change in the initial charging of the vanadium, which is contained in the active material supported on the electrode for the negative side, is divalent. Further, the electrode for the positive side supports the active material such that the mole number of the vanadium of which maximum valence change is monovalent is not less than 1.5 times the mole number of the vanadium of which maximum valence change is divalent. The electrode for the positive side preferably supports the active material such that the mole number of the vanadium of which maximum valence change is monovalent takes a value in a range of 1.5 times to 2.5 times the mole number of the vanadium of which maximum valence change is divalent.

The manner for allowing the electrodes to support the active material can be exemplified by the following method. For example, in a case of using an aqueous solution of vanadium oxide sulfate (IV) having a constant molarity, the amount (mL) of the aqueous solution of vanadium oxide sulfate (IV) which is to be impregnated in the electrode for the negative side or the electrode for the positive side is changed. For example, the electrode for the negative side is impregnated with 1 mL of the aqueous solution of 1M (mol/L) vanadium oxide sulfate (IV). On the other hand, the electrode for the positive side is impregnated with not less than 1.5 mL of the aqueous solution of 1M (mol/L) vanadium oxide sulfate (IV). In the case that the aqueous solution of vanadium oxide sulfate (IV) having the constant molarity is used and that the amount of the aqueous solution of vanadium oxide sulfate (IV) used for the negative electrode is 1 mL, the amount of the aqueous solution of vanadium oxide sulfate (IV) used for the positive electrode is preferably in a range of 1.5 mL to 2.5 mL.

Further, in order to allow the electrodes to support the active material by, for example, using an aqueous solution of vanadium oxide sulfate (IV) at a constant amount, the concentration of the aqueous solution of vanadium oxide sulfate (IV) which is to be impregnated in the electrode for the negative or positive side is changed. For example, the electrode for the negative side is impregnated with 1 mL of the aqueous solution of 1M (mol/L) vanadium oxide sulfate (IV). On the other hand, the electrode for the positive side is impregnated with 1 mL of the aqueous solution of not less than 1.5M (mol/L) vanadium oxide sulfate (IV). In the case that the aqueous solution of vanadium oxide sulfate (IV) is used at the constant amount and that the concentration of the aqueous solution of vanadium oxide sulfate (IV) used for the negative electrode is 1M (mol/L), the concentration of the aqueous solution of vanadium oxide sulfate (IV) used for the positive electrode is preferably in a range of 1.5M (mol/L) to 2.5M (mol/L).

<Step S3 and Step S3′>

Steps S3 and S3′ are steps of drying the electrodes so as to evaporate any surplus liquid (as solution or water), to thereby allow the electrodes to support a deposited substance containing the vanadium of which oxidation number is tetravalent. In the present specification, the phrase “to evaporate any surplus liquid (as solution or water)” means allowing a small amount of the aqueous solution of sulfuric acid to remain and evaporating the remaining liquid other than the small amount. The amount of the aqueous solution of sulfuric acid is an exact or proper amount at which the battery may be in the state of charge (SOC) of 0% to 100%. Further, in the present disclosure, the phrase “allowing the electrode(s) to support” or “supported on (by) the electrode(s)” means that a deposited substance deposited from the solution by the drying is firmly fixed to the electrode(s).

In Step S3 and Step S3′, the electrodes are dried under the atmospheric pressure (about 1.01×10⁵ Pa) at a temperature in a range of normal temperature (about 20 degrees Celsius) to 180 degrees Celsius. The electrodes may be dried in a vacuum state. In a case that the electrodes are dried by being heated at a temperature not less than the normal temperature (20 degrees Celsius), the electrodes may be heated by using a hot plate. Further, the term “vacuum state” means being under a pressure lower than the atmospheric pressure, and is not particularly limited. The pressure lower than the atmospheric pressure (1.01×10⁵ Pa) is preferably not more than a degree of vacuum of 1×10⁵ Pa. The lower limit value of the degree of vacuum is not particularly limited; the degree of vacuum is preferably not less than 1×10² Pa. In a case that the pressure during the drying is in a range of 1×10² Pa to 1×10⁵ Pa, it is possible to make the pressure during the drying to be a vacuum state lower than the atmospheric pressure, by using all purpose means (widely used means) such as an aspirator, a vacuum pump, etc.

<Step S4>

Step S4 is a step of assembling the constituent parts and components so as to obtain a battery. The battery uses the first electrode for the positive side and the second electrode for the negative side. The battery has the separator which is arranged between the first and second electrodes and which allows hydrogen ions to pass therethrough. The first electrode has the first current collector arranged therein; the positive electrode includes the first electrode and the first current collector. The second electrode has the second current collector arranged therein; the negative electrode includes the second electrode and the second current collector. The vanadium solid-salt battery is assembled by inserting the first current collector, the first electrode, the separator, the second electrode, and the second current collector into the cell in this order. The constituent parts and components of the battery are not particularly limited, but are exemplified by the first current collector, the first electrode, the separator, the second electrode, the second current collector, and the cell. In addition, the electric wires to which the first and second current collectors are connected, respectively, are also included in the constituent parts/components of the battery.

<Step S5>

Step S5 is a step of pouring, to the assembled battery, the electrolyte in the exact or proper amount at which the battery may be in the state of charge (SOC) of 0% to 100%. It is preferable to use the aqueous solution of sulfuric acid as the electrolyte.

The phrase “electrolyte in an (the) exact or proper amount at which the battery may be in the state of charge (SOC) of 0% to 100%” or “an (the) exact or proper amount, of the electrolyte, at which the battery may be in the state of charge (SOC) of 0% to 100%” is, for example, 70 mL of 2M (mol/L) sulfuric acid with respect to 100 g of vanadium oxide sulfate (IV) in the entire battery.

The vanadium solid-salt battery of the present disclosure is produced by the above-described method. The vanadium solid-salt battery contains the vanadium, of which oxidation number in the initial state is tetravalent, in the positive and negative electrodes. Further, in the vanadium solid-salt battery, the maximum valence change in the initial charging of the vanadium contained in the negative electrode is divalent, and the maximum valence change in the initial charging of the vanadium contained in the positive electrode is monovalent. Furthermore, in the vanadium solid-salt battery, the mole number of the vanadium of which maximum valence change is monovalent is not less than 1.5 times the mole number of the vanadium of which maximum valence change is divalent.

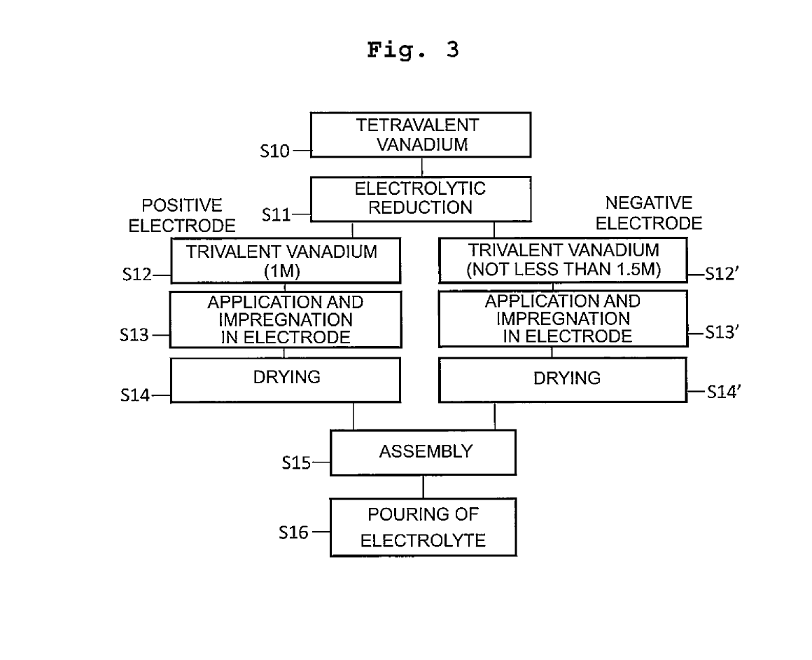

Next, another embodiment of the method for producing the vanadium solid-salt battery will be explained. FIG. 3 is a flowchart depicting another embodiment of the method for producing vanadium solid-salt battery. Steps for producing the vanadium solid-salt battery includes steps S10 to S16. Steps S10 and S11 are steps for subjecting a solution containing vanadium of which oxidation number is tetravalent to electrolytic reduction to thereby prepare a solution containing vanadium of which oxidation number is trivalent. Steps S12 to S14 and Steps S12′ to S14′ are steps for allowing electrodes constructing the positive and negative electrodes, respectively, to support an active material containing vanadium of which oxidation number in the initial state is trivalent. Steps S15 and S16 are steps for assembling constitutive parts and components to thereby obtain a battery. Steps S12 to S14 and Steps S12′ to S14′ contain same steps. Note, however, that Steps S12 to S14 and Steps S12′ to S14′ are different in the amount (mL) of the solution which contains the vanadium having trivalent oxidation number and which is impregnated in the electrodes.

<Step S10>

Step S10 is a step of preparing a solution containing the vanadium of which oxidation number is tetravalent. The vanadium of which oxidation number is tetravalent can be exemplified by a vanadium ion (V⁴⁺) or a cation (VO²⁺) including vanadium. The phrase “solution containing (the) vanadium of which oxidation number is tetravalent” or “solution containing (the) vanadium having (the) tetravalent oxidation number” can be exemplified, for example, by an aqueous solution of vanadium oxide sulfate (IV) (VOSO₄.nH₂O).

<Step S11>

Step S11 is a step of subjecting the solution containing vanadium of which oxidation number is tetravalent to the electrolytic reduction.

The electrolytic reduction is performed, for example, by energizing the solution containing vanadium of which oxidation number is tetravalent with a constant voltage of 1 A for 5 hours. The electrolytic reduction uses two electrodes and a separator separating the two electrodes from each other. After performing the electrolytic reduction, the inventors visually confirm that the color of the solution has changed from blue to purple completely. Next, the solution is left as it is in the air for 12 hours. Then, a solution containing vanadium of which oxidation number is trivalent (vanadium having trivalent oxidation number) can be obtained. The color of the solution is green. The electrolytic reduction may be performed while noble gas bubbling is being conducted by using, for example, argon. Further, the electrolytic reduction may be performed while maintaining the temperature of the solution at a constant temperature. The constant temperature at which the electrolytic reduction is performed is preferably in a range of 10 degrees Celsius to 30 degrees Celsius. Furthermore, the electrodes with which the electrolytic reduction is performed may use a platinum plate. As the separator with which the electrolytic reduction is performed, it is possible to use, for example, an ion-exchange membrane such as “SELEMION (trade name) APS” (manufactured by Asahi Glass Co., Ltd.), etc.

<Step S12 and Step S12′>

Each of Step S12 and Step S12′ is step of preparing a solution containing the vanadium of which oxidation number is trivalent by the electrolytic reduction. Here, the vanadium of which oxidation number is trivalent can be exemplified by a vanadium ion (V³⁺). The phrase “solution containing (the) vanadium of which oxidation number is trivalent” or “solution containing (the) vanadium having (the) trivalent oxidation number” can be exemplified, for example, by an aqueous solution of vanadium sulfate (III) (V₂(SO₄)₃.nH₂O).

The concentration of the solution of vanadium sulfate (III) is designed depending on the change in valence of the vanadium in each of the positive and negative electrodes. The concentration of the solution of vanadium sulfate (III) is preferably in a range of 1M (mol/L) to 3M (mol/L). The concentration of the solution of vanadium sulfate (III) is more preferably in a range of 1.5 M(mol/L) to 2.5 M(mol/L). The concentration of the vanadium compound in the solution is preferably changed depending on the kind of the electrode, the thickness of the electrode, etc.

The vanadium of which oxidation number is trivalent is an active material of the electrode. In a case of using the vanadium of which oxidation number is trivalent as the active material, the active material is supported on (by) the electrodes in such a manner that the maximum valence change in initial charging of the vanadium, which is contained in the active material supported on the electrode for the positive side, is divalent; and that the maximum valence change in the initial charging of the vanadium, which is contained in the active material supported on the electrode for the negative side, is monovalent. Further, the electrode for the negative side supports the active material such that the mole number of the vanadium of which maximum valence change is monovalent is not less than 1.5 times the mole number of the vanadium of which maximum valence change is divalent. The electrode for the negative side preferably supports the active material such that the mole number of the vanadium of which maximum valence change is monovalent takes a value in a range of 1.5 times to 2.5 times the mole number of the vanadium of which maximum valence change is divalent.

The manner for allowing the electrodes to support the active material can be exemplified by the following method. For example, in a case of using an aqueous solution of vanadium sulfate (III) having a constant molarity, the amount(mL) of the aqueous solution of vanadium sulfate (III) which is to be impregnated in the electrode for the negative side or the electrode for the positive side is changed. For example, the electrode for the positive side is impregnated with 1 mL of the aqueous solution of 1M (mol/L) vanadium sulfate (III). On the other hand, the electrode for the negative side is impregnated with not less than 1.5 mL of the aqueous solution of 1M (mol/L) vanadium sulfate (III). In the case that the aqueous solution of vanadium sulfate (III) having the constant concentration is used and that the amount of the aqueous solution of vanadium sulfate (III) used for the positive electrode is 1 mL, the amount of the aqueous solution of vanadium sulfate (III) used for the negative electrode is preferably in a range of 1.5 mL to 2.5 mL.

Further, in order to allow the electrodes to support the active material by using, for example, an aqueous solution of vanadium sulfate (III) at a constant amount, the concentration of the aqueous solution of vanadium sulfate (III) which is to be impregnated in the electrode for the negative or positive side is changed. For example, the electrode for the positive side is impregnated with 1 mL of the aqueous solution of 1M (mol/L) vanadium sulfate (III). On the other hand, the electrode for the negative side is impregnated with 1 mL of the aqueous solution of not less than 1.5M (mol/L) vanadium sulfate (III). In the case that the aqueous solution of vanadium sulfate (III) is used at the constant amount and that the concentration of the aqueous solution of vanadium sulfate (III) used for the positive electrode is 1M (mol/L), the concentration of the aqueous solution of vanadium sulfate (III) used for the negative electrode is preferably in a range of 1.5M (mol/L) to 2.5M (mol/L).

<Step 13 and Step S13′>

Steps S13 and S13′ are steps of impregnating the electrodes with the solution containing the vanadium of which oxidation number is trivalent, or of applying the solution to the electrodes.

<Step S14 and Step S14′>

Steps S14 and S14′ are steps for drying the electrodes so as to evaporate any surplus liquid (as solution or water), to thereby allow the electrodes to support a deposited substance containing the vanadium of which oxidation number is trivalent. Steps S14 and S14′ may use a method similar to that used in Steps S3 and S3′.

<Step S15>

Step S15 is a step of assembling the constituent parts and components so as to obtain a battery. Step S15 may use a method similar to that used in Step S4.

<Step S16>

Step S16 is a step of pouring, to the assembled battery, the electrolyte in the exact or proper amount at which the battery may be in the state of charge (SOC) of 0% to 100%. It is preferable to use the aqueous solution of sulfuric acid as the electrolyte. The phrase “electrolyte in an (the) exact or proper amount at which the battery may be in the state of charge (SOC) of 0% to 100%” or “an (the) exact or proper amount, of the electrolyte, at which the battery may be in the state of charge (SOC) of 0% to 100%” is, for example, 70 mL of 2M (mol/L) sulfuric acid with respect to 100 g of vanadium sulfate (III) in the entire battery.

The vanadium solid-salt battery of the present disclosure contains, in each of the positive and negative electrodes, vanadium of which oxidation number in the initial state is trivalent. Further, in the vanadium solid-salt battery of the present disclosure, the maximum valence change in the initial charging of the vanadium, which is contained in the positive electrode, is divalent; and the maximum valence change in the initial charging of the vanadium, which is contained in the negative electrode, is monovalent. Furthermore, in the vanadium solid-salt battery of the present disclosure, the mole number of the vanadium of which maximum valence change is monovalent is not less than 1.5 times the mole number of the vanadium of which maximum valence change is divalent.

In the present disclosure, either one of the positive and negative electrodes is allowed to contain the vanadium of which maximum change in valence (maximum valence change) is divalent so as to increase the standard electrode potential, thereby making it possible to increase the standard electromotive force of the vanadium solid-salt battery. Further, in the present disclosure, the mole number of the vanadium of which maximum valence change is monovalent is not less than 1.5 times the mole number of the vanadium of which maximum valence change is divalent. With this, the valence of vanadium can be changed maximally to divalence. Accordingly, the present disclosure is capable of providing a vanadium solid-salt battery with increased battery capacity, and a method for producing such a vanadium solid-salt battery. Further, the present disclosure is capable of providing a vanadium solid-salt battery with high energy density and a method for producing such a vanadium solid-salt battery.

### EXAMPLES

Next, a specific aspect of the present disclosure will be explained based on examples together with comparative examples. However, the present disclosure is not limited and is not restricted to the examples and comparative examples.

<Electrode>

As the electrode, a commercially available carbon felt having basis weight of 330 g/m² and thickness of 4.2 mm was used.

<Separator>

As the separator, “SELEMION (trade name) APS” (manufactured by Asahi Glass Co., Ltd.) was used.

<Current collector>

As the current collectors, those obtained by combining and stacking a graphite sheet (thickness: 40 μm) and a copper foil (thickness: 40 μm) with respect to each other were used.

### Solution of Active Material of Examples 1 to 3 and Comparative Example 1

The solution of active material was obtained by adding 2.2M (mol/L) sulfuric acid to 498 g of vanadium oxide sulfate (IV).nH₂O(VOSO₄.nH₂O)(content ratio of VOSO₄: 72%; VOSO₄: 358.6 g, 2.2 mol) to prepare a mixture of 1 L, followed by being agitated.

### Example 1

With respect to the first electrode, 0.45 mL of an aqueous solution of 2.2M (mol/L) vanadium oxide sulfate (IV)(VOSO₄.nH₂O) was impregnated per 2.16 cm² of the electrode. This first electrode was dried for 1 hour under a condition of 60 degrees Celsius and 1×10³ Pa. After the drying, the first electrode was impregnated with (supported) an active material containing tetravalent vanadium in the initial state. The mole number of the tetravalent vanadium supported on the first electrode was 0.99 mmol. The first electrode was used as the electrode for positive side. With respect to the second electrode, 0.3 mL of the aqueous solution of 2.2M (mol/L) vanadium oxide sulfate (IV)(VOSO₄.nH₂O) was impregnated per 2.16 cm² of the electrode. This second electrode was dried for 1 hour under a condition of 60 degrees Celsius and 1×10³ Pa. After the drying, the second electrode was impregnated with (supported) an active material containing tetravalent vanadium in the initial state. The mole number of the tetravalent vanadium supported on the second electrode was 0.66 mmol. The second electrode was used as the electrode for negative side. The mole number of the tetravalent vanadium in the first electrode (positive electrode) was 1.5 times the mole number of the tetravalent vanadium in the second electrode (negative electrode). In the positive electrode, a first current collector having a size same as that of the first electrode was arranged in the first electrode, so as to provide the first current collector. In the negative electrode, a second current collector having a size same as that of the second electrode was arranged in the second electrode, so as to provide the second current collector. A separator was arranged in the space between the first and second electrodes. A single stack was produced by stacking the first current collector, the first electrode, the separator, the second electrode and the second current collector in this order. The vanadium solid-salt battery was produced by inserting this single stack into a cylindrical cell having a base area of 2.16 cm² and a thickness of 3 mm. In the vanadium solid-salt battery, 0.5 mL of 2M (mol/L) sulfuric acid was added into the cell, as an electrolyte. Conductive carbon fiber was connected to each of the first and second current collectors in the cell, as the electric wire, thereby producing the vanadium solid-salt battery.

### Example 2

The mole number of the tetravalent vanadium supported on the first electrode (positive electrode) was changed to 2 times the mole number of the tetravalent vanadium supported on the second electrode (negative electrode). The vanadium solid-salt battery of Example 2 was produced in a similar manner as in Example 1, except that the mole number of the tetravalent vanadium supported on the first electrode was changed.

### Example 3

The mole number of the tetravalent vanadium supported on the first electrode (positive electrode) was changed to 2.5 times the mole number of the tetravalent vanadium supported on the second electrode (negative electrode). The vanadium solid-salt battery of Example 3 was produced in a similar manner as in Example 1, except that the mole number of the tetravalent vanadium supported on the first electrode was changed.

### Comparative Example 1

The mole number of the tetravalent vanadium supported on the first electrode (positive electrode) was changed to 1 time the mole number of the tetravalent vanadium supported on the second electrode (negative electrode). The vanadium solid-salt battery of Comparative Example 1 was produced in a similar manner as in Example 1, except that the mole number of the tetravalent vanadium supported on the first electrode was changed.

TABLE 1 indicates the ratio of the mole number of vanadium in the positive electrode to the mole number of vanadium in the negative electrode; the ratio of the theoretical capacity of the positive electrode to the theoretical capacity of the negative electrode (unit: Ah); the ratio of impregnation of the vanadium oxide sulfate (IV) aqueous solution in the positive electrode to that in the negative electrode (unit: mL), and the mole ratio of vanadium in the negative electrode to vanadium in the positive electrode (unit: mmol), in Examples 1 to 3 and Comparative Example 1.

Note that in TABLE 1 and TABLES 2 to 6 (to be described later on), the term “EX” and “COM. EX” represent “Example” and “Comparative Example”, respectively.

TABLE 1

| | Ratio of mole | Ratio of | Vanadium oxide sulfate | |
|---|---|---|---|---|
| | number of vanadium | theoretical capacity | (IV) aqueous solution | Mole ratio |
| | Positive:Negative | Positive:Negative | Positive:Negative | Positive:Negative |
| | electrode electrode | electrode electrode | electrode electrode | electrode electrode |
| COM. | 1:1 | 17 mAh:17 mAh | 0.3 mL:0.3 mL | 0.66 mol:0.66 mol |
| EX. 1 | | | | |
| EX. 1 | 1.5:1 | 25.5 mAh:17 mAh | 0.45 mL:0.3 mL | 0.99 mol:0.66 mol |
| EX. 2 | 2:1 | 34 mAh:17 mAh | 0.6 mL:0.3 mL | 1.32 mol:0.66 mol |
| EX. 3 | 2.5:1 | 42.5 mAh:17 mAh | 0.75 mL:0.3 mL | 1.65 mol:0.66 mol |

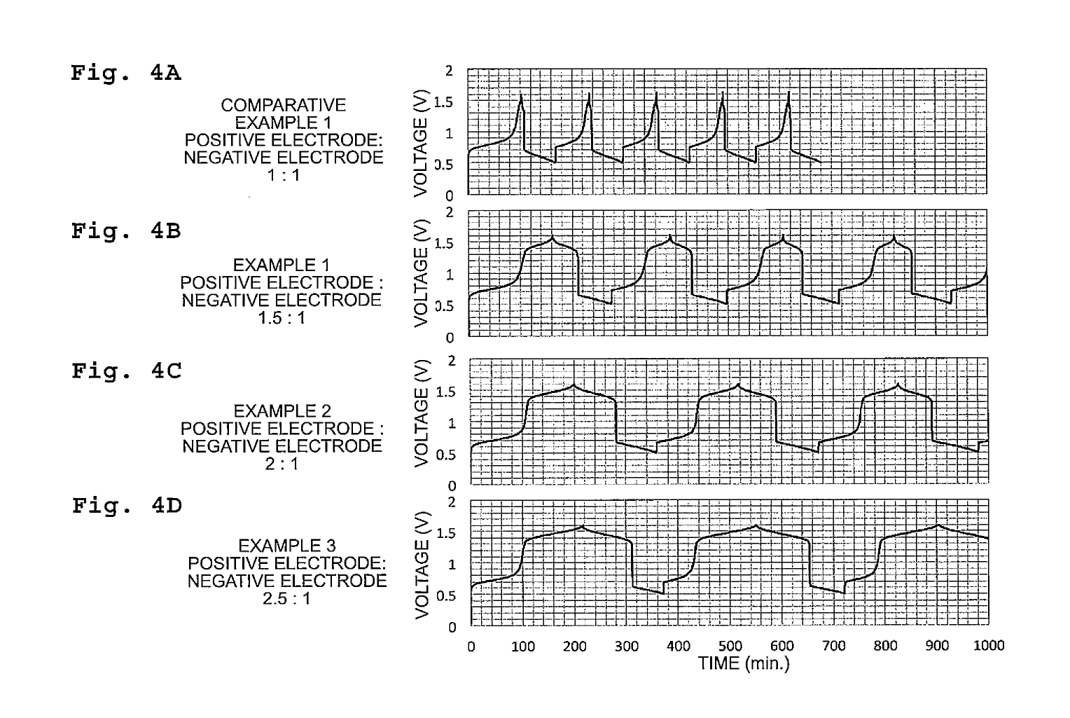

The following charge/discharge test was conducted for the vanadium solid-salt batteries of Examples 1 to 3 and Comparative Example 1, and the discharge capacity and electric energy thereof were measured. The results are indicated in TABLE 2 and TABLE 3, and in FIGS. 4 to 6. In FIGS. 4 to 6, the ratio of “the mole number of vanadium (V) in the positive electrode:the mole number of vanadium (V) in the negative electrode” is abbreviated as “positive electrode:negative electrode”.

<Discharge Capacity>

The measurement of the discharge capacity was performed by using a discharge and charge testing device (model name: TOSCAT-3500, manufactured by Toyo System Co., Ltd.). In the measurement of discharge capacity (mAh), charging/discharging in which the vanadium solid-salt battery was charged up to 1.6 V at 17 mA/cm² under the room temperature condition and then the vanadium solid-salt battery was discharged up to 0.5 V was performed for 5 cycles; and the discharge capacity (mAh) was measured for each of the five cycles. The room temperature was about 20 degrees Celsius±5 degrees Celsius.

<Electric Energy>

The electric energy of the vanadium solid-salt batteries was measured in the following manner.

The measurement of the electric energy was performed by using the discharge and charge testing device (model name: TOSCAT-3500, manufactured by Toyo System Co., Ltd.). In the measurement of electric energy (mWh), charging/discharging in which the vanadium solid-salt battery was charged up to 1.6 V at 17 mA/cm² under the room temperature condition and then the vanadium solid-salt battery was discharged up to 0.5 V was performed for 5 cycles; and the electric energy (mWh) was measured for each of the five cycles. The room temperature was about 20 degrees Celsius±5 degrees Celsius.

TABLE 2 indicates the maximum discharge capacity (mAh) among the measurement performed for 5 cycles for the vanadium solid-salt battery of each of Examples 1 to 3 and Comparative Example 1. Further, TABLE 2 indicates a numerical value (Ah.mol⁻¹) obtained by dividing the maximum discharge capacity (mAh) by the mole number of the active material in the both positive and negative electrodes, and a numerical value (Ah.mol⁻¹) obtained by dividing the maximum discharge capacity (mAh) by the mole number of the active material in the positive electrode.

TABLE 3 indicates the maximum electric energy (mWh) among the measurement performed for 5 cycles for the vanadium solid-salt battery of each of Examples 1 to 3 and Comparative Example 1. Further, TABLE 3 indicates a numerical value (Wh.mol⁻¹) obtained by dividing the maximum electric energy (mWh) by the mole number of the active material in the both positive and negative electrodes, and a numerical value (Wh.mol⁻¹) obtained by dividing the maximum electric energy (mWh) by the mole number of the active material in the positive electrode.

TABLE 2

| | Maximum | | Maximum discharge capacity/ | Maximum discharge capacity/ |
|---|---|---|---|---|
| | discharge | Mole ratio | Mole number of active | Mole number of active |
| | capacity | Positive:Negative | material in both | material in positive |
| | (mAh) | electrode electrode | electrodes (Ah · mol⁻¹) | electrode (Ah · mol⁻¹) |
| COM. | 10.707 | 0.66 mol:0.66 mol | 8.111 | 16.223 |
| EX. 1 | | | | |
| EX. 1 | 18.690 | 0.99 mol:0.66 mol | 11.327 | 18.879 |
| EX. 2 | 26.426 | 1.32 mol:0.66 mol | 13.347 | 20.020 |
| EX. 3 | 30.188 | 1.65 mol:0.66 mol | 13.068 | 18.296 |

As indicated in TABLE 2, the vanadium solid-salt battery of each of Examples 1 to 3 had the maximum discharge capacity increased to be more than that of the vanadium solid-salt battery of Comparative Example 1. Further, as indicated in the item of “Maximum discharge capacity/Mole number of active material in both electrodes (Ah.mol⁻¹)” in TABLE 2, the vanadium solid-salt batteries of Examples 1 and 2 had the discharge capacity increased to be not less than a numerical value proportional to the increased amount of the active material in the both electrodes, with respect to Comparative Example 1. The total of the mole number of the active material in the both electrodes in Example 1 is 1.25 times the total: 1 of the mole number of the active material in the both electrodes in Comparative Example 1. The “Maximum discharge capacity/Mole number of active material in both electrodes (Ah.mol⁻)” of Example 1 is approximately 1.40 times the “Maximum discharge capacity/Mole number of active material in both electrodes (Ah.mol¹⁻)” of Comparative Example 1. The total of the mole number of the active material in the both electrodes in Example 2 is 1.5 times the total: 1 of the mole number of the active material in the both electrodes in Comparative Example 1. The “Maximum discharge capacity/Mole number of active material in both electrodes (Ah.mol⁻¹)” of Example 2 is approximately 1.65 times the “Maximum discharge capacity/Mole number of active material in both electrodes (Ah.mol⁻¹)” of Comparative Example 1.

From the results of Examples 1 to 3, it was appreciated that the vanadium solid-salt battery of each of Examples 1 to 3 was capable of increasing the discharge capacity. In the vanadium solid-salt battery of each of Examples 1 to 3, the mole number of the vanadium of which maximum valence change is monovalent is not less than 1.5 times the mole number of the vanadium of which maximum valence change is divalent. Further, from the results of Examples 1 to 3, it was appreciated that the vanadium solid-salt battery of each of Examples 1 to 3 was capable of increasing the capacity to be not less than the numerical value proportional to the increased mole number of the active material. In the vanadium solid-salt battery of each of Examples 1 to 3, the mole number of the vanadium of which maximum valence change is monovalent takes a value in a range of 1.5 times to 2.5 times the mole number of the vanadium of which maximum valence change is divalent.

TABLE 3

| | Maximum | | Maximum electric power/ | Maximum electric power/ |
|---|---|---|---|---|
| | electric | Mole ratio | Mole number of active | Mole number of active |
| | power | Positive:Negative | material in both | material in positive |
| | (mWh) | electrode electrode | electrodes (Wh · mol⁻¹) | electrode (Wh · mol⁻¹) |
| COM. | 7.045 | 0.66 mol:0.66 mol | 5.337 | 10.674 |
| EX. 1 | | | | |
| EX. 1 | 17.586 | 0.99 mol:0.66 mol | 10.658 | 17.764 |
| EX. 2 | 27.018 | 1.32 mol:0.66 mol | 13.646 | 20.468 |
| EX. 3 | 32.632 | 1.65 mol:0.66 mol | 14.126 | 19.777 |

As indicated in TABLE 3, the vanadium solid-salt battery of each of Examples 1 to 3 had the maximum electric power increased to be more than that of the vanadium solid-salt battery of Comparative Example 1. As indicated in the item of “Maximum electric power/Mole number of active material in both electrodes (Wh.mol⁻¹)” in TABLE 3, the vanadium solid-salt batteries of Examples 1 to 3 had the energy density increased to be not less than a numerical value proportional to the increased amount of the active material in the both electrodes with respect to Comparative Example 1. The total of the mole number of the active material in the both electrodes in Example 1 is 1.25 times the total: 1 of the mole number of the active material in the both electrodes in Comparative Example 1. The “Maximum electric power/Mole number of active material in both electrodes (Wh.mol⁻¹)” of Example 1 is approximately 2 times the “Maximum electric power/Mole number of active material in both electrodes (Wh.mol⁻¹)” of Comparative Example 1. The total of the mole number of the active material in the both electrodes in Example 2 is 1.5 times the total: 1 of the mole number of the active material in the both electrodes in Comparative Example 1. The “Maximum electric power/Mole number of active material in both electrodes (Wh.mol⁻¹)” of Example 2 is approximately 2.56 times the “Maximum electric power/Mole number of active material in both electrodes (Wh.mol⁻¹)” of Comparative Example 1. The total of the mole number of the active material in the both electrodes in Example 3 is 1.75 times the total: 1 of the mole number of the active material in the both electrodes in Comparative Example 1. The “Maximum electric power/Mole number of active material in both electrodes (Wh.mol⁻¹)” of Example 3 is approximately 2.65 times the “Maximum electric power/Mole number of active material in both electrodes (Wh.mol⁻¹)” of Comparative Example 1.

From the results of Examples 1 to 3, it was appreciated that the vanadium solid-salt battery of each of Examples 1 to 3 was capable of increasing the energy density of the vanadium solid-salt battery. In the vanadium solid-salt battery of each of Examples 1 to 3, the mole number of the vanadium of which maximum valence change is monovalent is not less than 1.5 times the mole number of the vanadium of which maximum valence change is divalent. Further, from the results of Examples 1 to 3, it was appreciated that the vanadium solid-salt battery of each of Examples 1 to 3 was capable of increasing the energy density to be not less than the numerical value proportional to the increased mole number of the active material. In the vanadium solid-salt battery of each of Examples 1 to 3, the mole number of the vanadium of which maximum valence change is monovalent takes a value in a range of 1.5 times to 2.5 times the mole number of the vanadium of which maximum valence change is divalent.

FIG. 4 depicts time-voltage curve in the charge-discharge test. In FIG. 4, FIG. 4(a) depicts the result regarding Comparative Example 1 (V Mole number of positive electrode: V Mole number of negative electrode=1:1), FIG. 4(b) depicts the result regarding Example 1 (V Mole number of positive electrode: V Mole number of negative electrode=1.5:1), FIG. 4(c) depicts the result regarding Example 2 (V Mole number of positive electrode: V Mole number of negative electrode=2:1), and FIG. 4(d) depicts the result regarding Example 3 (V Mole number of positive electrode: V Mole number of negative electrode=2.5:1). It was confirmed that even when the charge/discharge cycle indicated in FIG. 4 was repeated, the time-voltage curve in the charge-discharge test did not change greatly. Further, in the vanadium solid-salt batteries of Examples 1 to 3 and of Comparative Example 1, the charge/discharge time was longer proportional to the amount of the active material supported on the vanadium solid-salt battery.

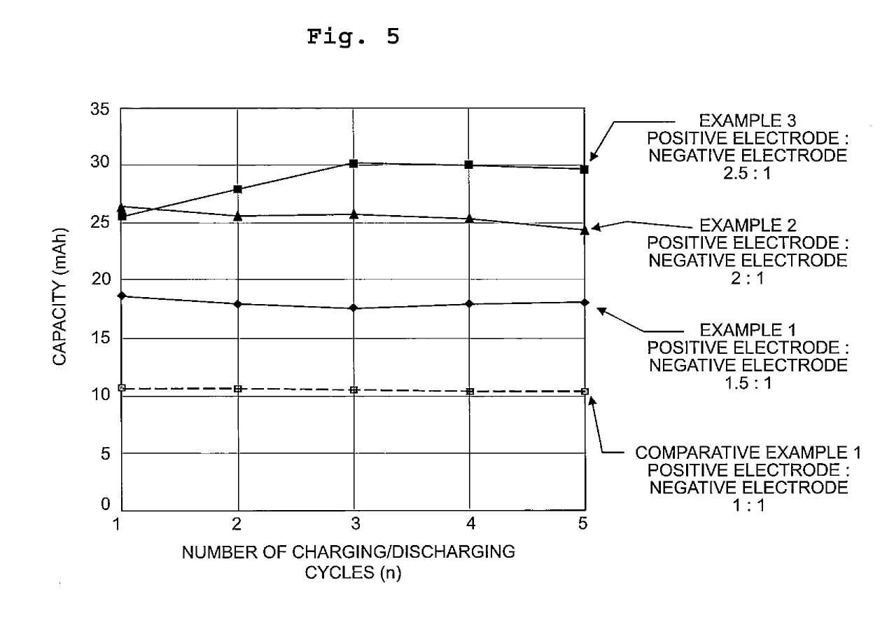

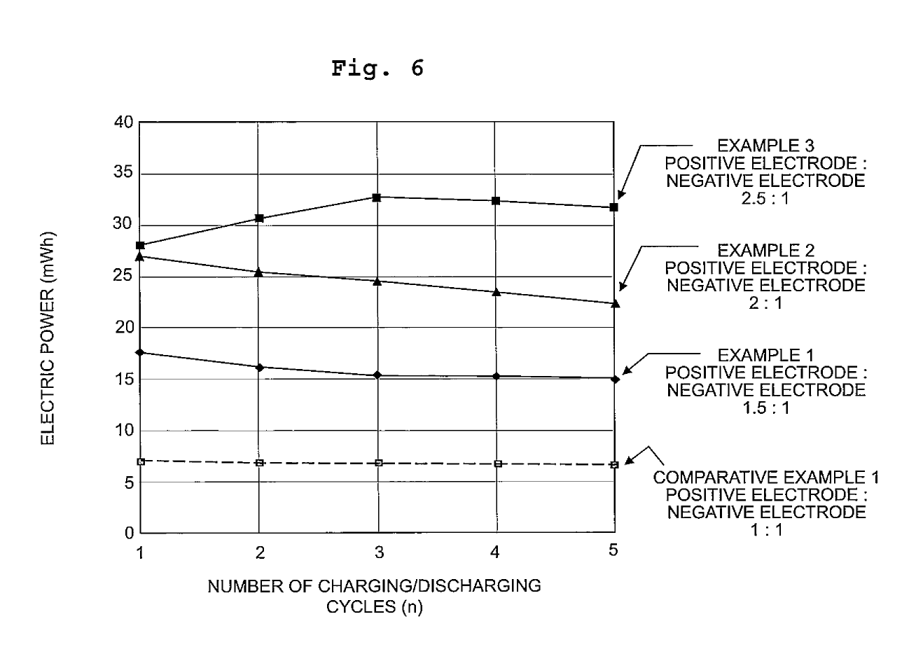

FIG. 5 depicts a relationship between number of charging/discharging cycles (n) and battery capacity (mAh) in the charge-discharge test conducted for Examples 1 to 3 and Comparative Example 1. FIG. 6 depicts a relationship between the number of charging/discharging cycles (n) and amount of electric power (mWh) in the charge-discharge test conducted for Examples 1 to 3 and Comparative Example 1. As indicated in FIGS. 5 and 6, it was confirmed that even when the charge/discharge cycle was repeated, each of the capacity (mAh) and the electric power (mWh) of the battery had a substantially constant value, and behaved stably. Further, as indicated in FIG. 5, the vanadium solid-salt battery of each of Examples 1 to 3 had the capacity increased to be greater than that of the vanadium solid-salt battery of Comparative Example 1. Furthermore, as indicated in FIG. 6, the vanadium solid-salt battery of each of Examples 1 to 3 had the energy density higher than that of the vanadium solid-salt battery of Comparative Example 1.

### Solution of Active Material of Examples 4 to 6 and Comparative Example 2

A preparatory solution to be prepared as a solution of active material was obtained by adding sulfuric acid to vanadium oxide sulfate (IV).nH₂O(VOSO₄.nH₂O) to prepare a mixture of 1 L, followed by being agitated. This preparatory solution was subjected to the electrolytic reduction. As working electrodes for performing the electrolytic reduction, platinum plates were used. As a separator for performing the electrolytic reduction, an ion-exchange membrane (“SELEMION (trade name) APS”, manufactured by Asahi Glass Co., Ltd.) was used. At first, the preparatory solution was poured into a beaker-shaped cell. Next, noble gas bubbling was conducted by using, for example, argon (Ar) gas, for the preparatory solution poured into the beak-shaped cell. Subsequently, the electrolytic reduction was performed by energizing the preparatory solution with a constant voltage of 1 A for 5 hours, while the temperature of the preparatory solution was maintained at 15 degrees Celsius and while the bubbling was continued with the Ar gas. Afterwards, the preparatory solution was poured from the beaker-shaped cell into a petri dish. The preparatory solution poured into the petri dish was left as it was in the air for 12 hours. After the preparatory solution was left in the air as it was for 12 hours, the inventors visually confirmed that the color of the preparatory solution had changed from purple to green completely. Next, the preparatory solution was dried at reduced pressure (degree of vacuum: not more than 1.0×10⁵ Pa) at the room temperature (about 20 degrees Celsius±5 degrees Celsius) for 1 week. Afterwards, 1030 g of vanadium sulfate (III).nH₂O (content ratio of (V₂(SO₄)_{3:} 84%; V₂(SO₄)_{3:} 858 g; 2.2 mol) could be obtained from the preparatory solution. A solution of active material was obtained by adding 2.2 M (mol/L) sulfuric acid to vanadium sulfate (III).nH₂O(V₂(SO₄)₃.nH₂O) to prepare a mixture of 1 L.

### Example 4

With respect to the first electrode, 0.3 mL of an aqueous solution of 2.2 M (mol/L) vanadium sulfate (III) (V₂(SO₄)₃.nH₂O) was impregnated per 2.16 cm² of the electrode. This first electrode was dried for 1 hour under a condition of 60 degrees Celsius and 1×10³ Pa. After the drying, the first electrode was impregnated with (supported) an active material containing trivalent vanadium in the initial state. The mole number of the trivalent vanadium supported on the first electrode was 0.66 mmol. The first electrode was used as the electrode for positive side.

With respect to the second electrode, 0.45 mL of the aqueous solution of 2.2 M (mol/L) vanadium sulfate (III) (V₂(SO₄)₃.nH₂O) was impregnated per 2.16 cm² of the electrode. This second electrode was dried for 1 hour under a condition of 60 degrees Celsius and 1×10³ Pa. After the drying, the second electrode was impregnated with (supported) an active material containing trivalent vanadium in the initial state. The mole number of the trivalent vanadium supported on the second electrode was 0.99 mmol. The second electrode was used as the electrode for negative side. The mole number of the trivalent vanadium in the second electrode (negative electrode) was 1.5 times the mole number of the trivalent vanadium in the first electrode (positive electrode). The vanadium solid-salt battery of Example 4 was produced by using the first and second electrodes in a same manner as in Example 1.

### Example 5

The mole number of the trivalent vanadium supported on the second electrode (negative electrode) was changed to 2 times the mole number of the trivalent vanadium supported on the first electrode (positive electrode). The vanadium solid-salt battery of Example 5 was produced in a similar manner as in Example 4, except that the mole number of the trivalent vanadium supported on the second electrode was changed.

### Example 6

The mole number of the trivalent vanadium supported on the second electrode (negative electrode) was changed to 2.5 times the mole number of the trivalent vanadium supported on the first electrode (positive electrode). The vanadium solid-salt battery of Example 6 was produced in a similar manner as in Example 4, except that the mole number of the trivalent vanadium supported on the second electrode was changed.

### Comparative Example 2

The mole number of the trivalent vanadium supported on the second electrode (negative electrode) was changed to 1 time the mole number of the trivalent vanadium supported on the first electrode (positive electrode). The vanadium solid-salt battery of Comparative Example 2 was produced in a similar manner as in Example 4, except that the mole number of the trivalent vanadium supported on the second electrode was changed.

TABLE 4 indicates the ratio of the mole number of vanadium in the positive electrode to the mole number of vanadium in the negative electrode; the ratio of the theoretical capacity of the positive electrode to the theoretical capacity of the negative electrode (unit: Ah); the ratio of impregnation of the vanadium sulfate (III) aqueous solution in the positive electrode to that in the negative electrode (unit: mL), and the mole ratio of vanadium in the negative electrode to vanadium in the positive electrode (unit: mmol), in Examples 4 to 6 and Comparative Example 2.

TABLE 4

| | Ratio of mole | Ratio of | Vanadium sulfate | |
|---|---|---|---|---|
| | number of vanadium | theoretical capacity | (III) aqueous solution | Mole ratio |
| | Positive:Negative | Positive:Negative | Positive:Negative | Positive:Negative |
| | electrode electrode | electrode electrode | electrode electrode | electrode electrode |
| COM. | 1:1 | 17 mAh:17 mAh | 0.3 mL:0.3 mL | 0.66 mol:0.66 mol |
| EX. 2 | | | | |
| EX. 4 | 1:1.5 | 17 mAh:25.5 mAh | 0.3 mL:0.45 mL | 0.66 mol:0.99 mol |
| EX. 5 | 1:2 | 17 mAh:34 mAh | 0.3 mL:0.6 mL | 0.66 mol:1.32 mol |
| EX. 6 | 1:2.5 | 17 mAh:42.5 mAh | 0.3 mL:0.75 mL | 0.66 mol:1.65 mol |

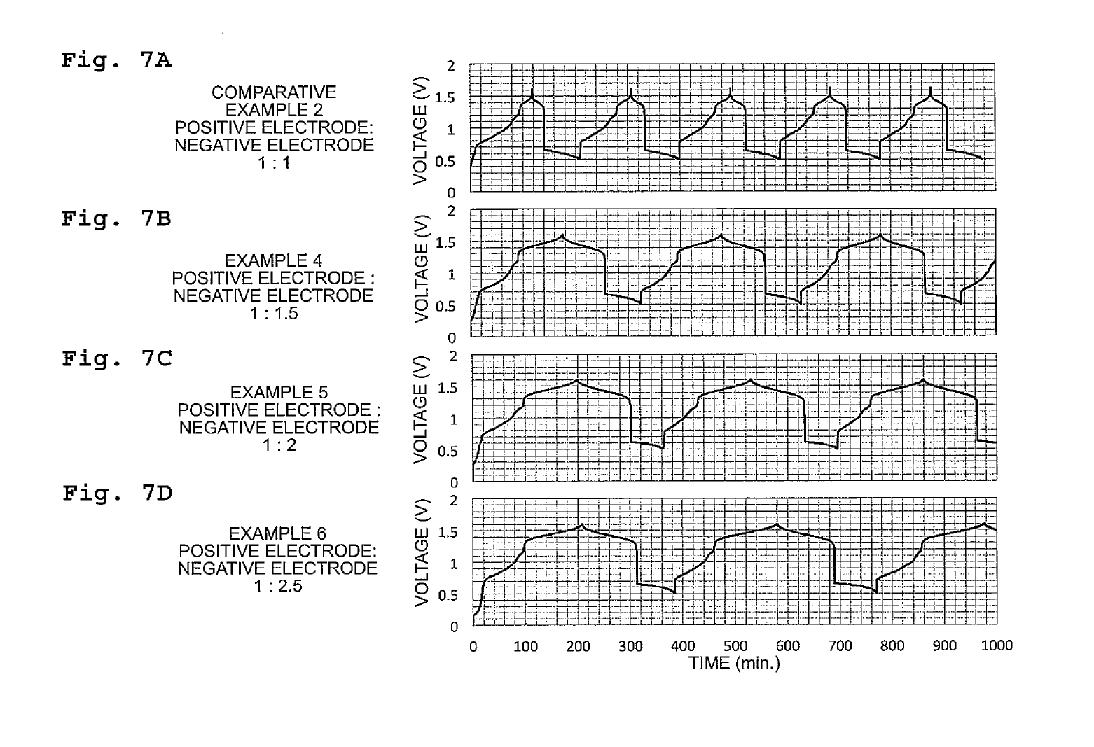

The charge/discharge test was conducted for the vanadium solid-salt batteries of Examples 4 to 6 and Comparative Example 2, in a similar manner as conducted for Example 1, and the discharge capacity and electric energy thereof were measured. The results are indicated in TABLE 5 and TABLE 6, and in FIGS. 7 to 9. In FIGS. 7 to 9, the ratio of “the mole number of vanadium (V) in the positive electrode:the mole number of vanadium (V) in the negative electrode” is abbreviated as “positive electrode:negative electrode”.

TABLE 5

| | Maximum | | Maximum discharge capacity/ | Maximum discharge capacity/ |
|---|---|---|---|---|
| | discharge | Mole ratio | Mole number of active | Mole number of active |
| | capacity | Positive:Negative | material in both | material in negative |
| | (mAh) | electrode electrode | electrodes (Ah · mol⁻¹) | electrode (Ah · mol⁻¹) |
| COM. | 16.354 | 0.66 mol:0.66 mol | 12.390 | 24.779 |
| EX. 2 | | | | |
| EX. 4 | 25.007 | 0.66 mol:0.99 mol | 15.156 | 25.260 |
| EX. 5 | 27.295 | 0.66 mol:1.32 mol | 13.785 | 20.678 |
| EX. 6 | 32.933 | 0.66 mol:1.65 mol | 14.257 | 19.959 |

As indicated in TABLE 5, the vanadium solid-salt battery of each of Examples 4 to 6 had the maximum discharge capacity increased to be more than that of the vanadium solid-salt battery of Comparative Example 2.

Further, as indicated in the item of “Maximum discharge capacity/Mole number of active material in both electrodes (Ah.mol⁻¹)” in TABLE 5, the vanadium solid-salt battery of Example 4 had the discharge capacity increased to the extent of a numerical value proportional to the increased amount of the active material in the both electrodes, with respect to Comparative Example 2. The total of the mole number of the active material in the both electrodes in Example 4 is 1.25 times the total: 1 of the mole number of the active material in the both electrodes in Comparative Example 2. The “Maximum discharge capacity/Mole number of active material in both electrodes (Ah.mol⁻¹)” of Example 4 is approximately 1.22 times the “Maximum discharge capacity/Mole number of active material in both electrodes (Ah.mol⁻)” of Comparative Example 2.

From the results of Examples 4 to 6, it was appreciated that the vanadium solid-salt battery of each of Examples 4 to 6 was capable of increasing the discharge capacity. In the vanadium solid-salt battery of each of Examples 4 to 6, the mole number of the vanadium of which maximum valence change is monovalent is not less than 1.5 times the mole number of the vanadium of which maximum valence change is divalent. Further, from the results of Examples 4 to 6, it was appreciated that the vanadium solid-salt battery of each of Examples 4 to 6 was capable of increasing the capacity to be not less than the numerical value proportional to the increased mole number of the active material. In the vanadium solid-salt battery of each of Examples 4 to 6, the mole number of the vanadium of which maximum valence change is monovalent takes a value in a range of 1.5 times to 2.5 times the mole number of the vanadium of which maximum valence change is divalent.

TABLE 6

| | Maximum | | Maximum electric power/ | Maximum electric power/ |
|---|---|---|---|---|
| | electric | Mol ratio | Mole number of active | Mole number of active |
| | power | Positive:Negative | material in both | material in negative |
| | (mWh) | electrode electrode | electrodes (Wh · mol⁻¹) | electrode (Wh · mol⁻¹) |
| COM. | 13.882 | 0.66 mol:0.66 mol | 10.517 | 21.034 |
| EX. 2 | | | | |
| EX. 4 | 23.883 | 0.66 mol:0.99 mol | 14.475 | 24.125 |
| EX. 5 | 29.994 | 0.66 mol:1.32 mol | 15.148 | 22.723 |
| EX. 6 | 34.830 | 0.66 mol:1.65 mol | 15.078 | 21.109 |

As indicated in TABLE 6, the vanadium solid-salt battery of each of Examples 4 to 6 had the maximum electric power increased to be more than that of the vanadium solid-salt battery of Comparative Example 2. As indicated in the item of “Maximum electric power/Mole number of active material in both electrodes (Wh.mol⁻¹)” in TABLE 6, the vanadium solid-salt batteries of Examples 4 and 5 had the energy density (Wh.mol⁻¹) increased to the extent of a numerical value proportional to the increased amount of the active material in the both electrodes, with respect to Comparative Example 2. The total of the mole number of the active material in the both electrodes in Example 4 is 1.25 times the total: 1 of the mole number of the active material in the both electrodes in Comparative Example 2. The “Maximum electric power/Mole number of active material in both electrodes (Wh.mol⁻¹)” of Example 4 is approximately 1.38 times the “Maximum electric power/Mole number of active material in both electrodes (Wh.mol⁻¹)” of Comparative Example 2. The total of the mole number of the active material in the both electrodes in Example 5 is 1.5 times the total: 1 of the mole number of the active material in the both electrodes in Comparative Example 2. The “Maximum electric power/Mole number of active material in both electrodes (Wh.mol⁻¹)” of Example 5 is approximately 1.44 times the “Maximum electric power/Mole number of active material in both electrodes (Wh.mol⁻¹)” of Comparative Example 2.

From the results of Examples 4 to 6, it was appreciated that the vanadium solid-salt battery of each of Examples 4 to 6 was capable of increasing the energy density of the vanadium solid-salt battery. In the vanadium solid-salt battery of each of Examples 4 to 6, the mole number of the vanadium of which maximum valence change is monovalent is not less than 1.5 times the mole number of the vanadium of which maximum valence change is divalent. Further, from the results of Examples 4 to 6, it was appreciated that the vanadium solid-salt battery of each of Examples 4 to 6 was capable of increasing the energy density to the extent of the numerical value proportional to the increased mole number of the active material. In the vanadium solid-salt battery of each of Examples 4 to 6, the mole number of the vanadium of which maximum valence change is monovalent takes a value in a range of 1.5 times to 2.5 times the mole number of the vanadium of which maximum valence change is divalent.

FIG. 7 depicts time-voltage curve in the charge-discharge test. In FIG. 7, FIG. 7(a) depicts the result regarding Comparative Example 2 (V Mole number of positive electrode: V Mole number of negative electrode=1:1), FIG. 7(b) depicts the result regarding Example 4 (V Mole number of positive electrode: V Mole number of negative electrode=1:1.5), FIG. 7(c) depicts the result regarding Example 5 (V Mole number of positive electrode: V Mole number of negative electrode=1:2), and FIG. 7(d) depicts the result regarding Example 6 (V Mole number of positive electrode: V Mole number of negative electrode=1:2.5). It was confirmed that even when the charge/discharge cycle indicated in FIG. 7 was repeated, the time-voltage curve in the charge-discharge test did not change greatly. Further, in the vanadium solid-salt batteries of Examples 4 to 6 and of Comparative Example 2, the charge/discharge time was longer proportional to the amount of the active material supported on the vanadium solid-salt battery.

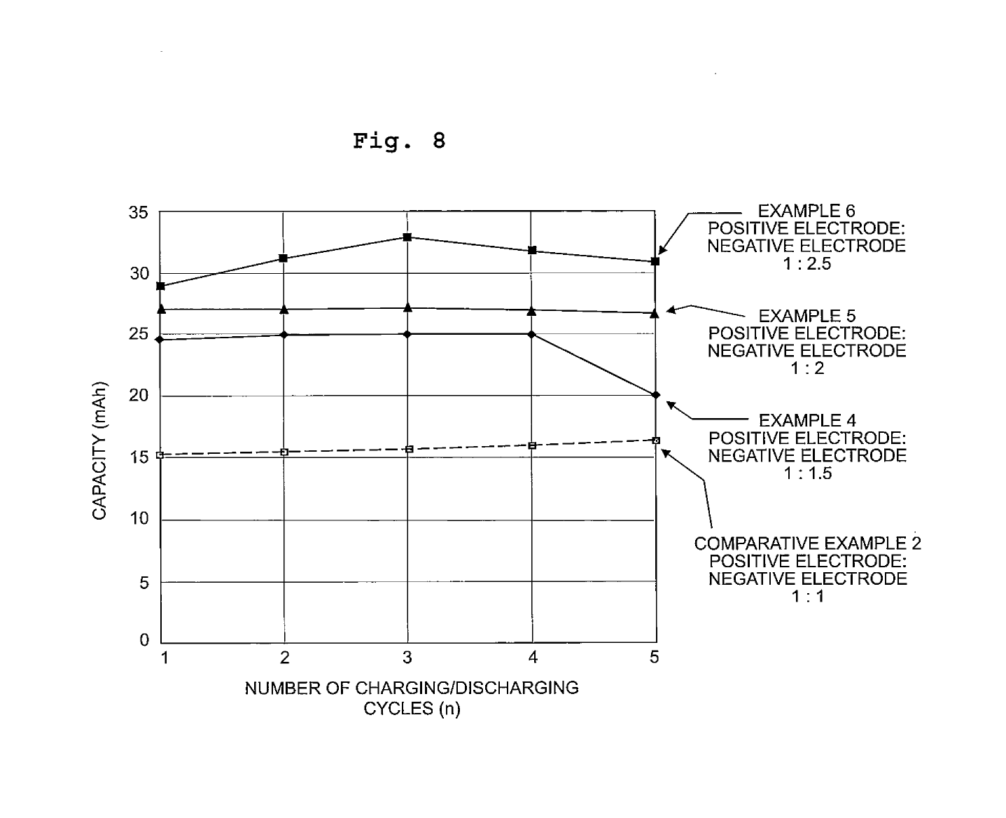

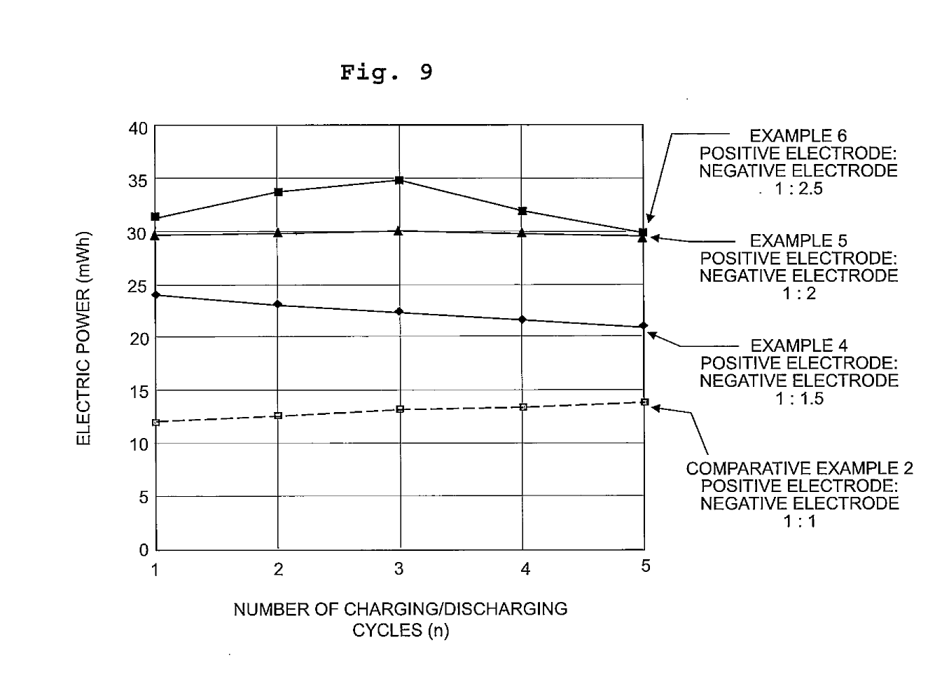

FIG. 8 depicts a relationship between number of charging/discharging cycles (n) and battery capacity (mAh) in the charge-discharge test conducted for Examples 4 to 6 and Comparative Example 2. FIG. 9 depicts a relationship between the number of charging/discharging cycles (n) and amount of electric power (mWh) in the charge-discharge test conducted for Examples 4 to 6 and Comparative Example 2. As indicated in FIGS. 8 and 9, it was confirmed that even when the charge/discharge cycle was repeated, each of the capacity (mAh) and the electric power (mWh) of the battery had a substantially constant value, and behaved stably. Further, as indicated in FIG. 8, the vanadium solid-salt battery of each of Examples 4 to 6 had the capacity increased to be greater than that of the vanadium solid-salt battery of Comparative Example 2. Furthermore, as indicated in FIG. 9, the vanadium solid-salt battery of each of Examples 4 to 6 had the energy density higher than that of the vanadium solid-salt battery of Comparative Example 2.

The present disclosure is capable of providing of a vanadium solid-salt battery with increased battery capacity. Further, the present disclosure is capable of providing a vanadium solid-salt battery with high energy density. Furthermore, the vanadium solid-salt battery can realize a light-weight, solid and sturdy product packaging (product mounting). Moreover, the vanadium solid-salt battery is widely usable not only in the field of large electric power storage, but also in personal computers, personal digital assistants (PDAs), digital cameras, digital media players, digital recorders, game devices, electrical appliances, vehicles, radio equipment, cellphones, etc., and is industrially useful.

The present disclosure has been explained in detail above. The present disclosure is summarized as follows according to the embodiments described above.

The present disclosure relates to a vanadium solid-salt battery including:

a positive electrode and a negative electrode each containing vanadium of which oxidation number in an initial state is either one of trivalent and tetravalent; and

a separator which separates the positive electrode from the negative electrode and which allows hydrogen ions to pass therethrough,

wherein maximum valence change in initial charging of the vanadium contained in one of the positive and negative electrodes is divalent, and the maximum valence change in the initial charging of the vanadium contained in the other of the positive and negative electrodes is monovalent; and

mole number of the vanadium of which maximum valence change is monovalent is not less than 1.5 times mole number of the vanadium of which maximum valence change is divalent.

In the vanadium solid-salt battery related to the present disclosure, each of the positive and negative electrodes contains the vanadium of which oxidation number in the initial state is tetravalent;

the maximum valence change in the initial charging of the vanadium contained in the positive electrode is monovalent; and

the maximum valence change in the initial charging of the vanadium contained in the negative electrode is divalent.

In the vanadium solid-salt battery related to the present disclosure, each of the positive and negative electrodes contains the vanadium of which oxidation number in the initial state is trivalent;

the maximum valence change in the initial charging of the vanadium contained in the positive electrode is divalent; and

the maximum valence change in the initial charging of the vanadium contained in the negative electrode is monovalent.

The present disclosure relates to a method for producing a vanadium solid-salt battery, the method including an active material supporting step of allowing electrodes constructing a positive electrode and a negative electrode, respectively, to support an active material thereon, the active material containing vanadium of which oxidation number in an initial state is either one of trivalent and tetravalent,

wherein in the active material supporting step, the electrodes are allowed to support the active material thereon such that one of the electrodes supports the active material containing the vanadium of which maximum valence change in initial charging is divalent, that the other of the electrodes supports the active material containing the vanadium of which maximum valence change in the initial charging is monovalent and that mole number of the active material including the vanadium of which maximum valence change is monovalent is not less than 1.5 times mole number of the active material including the vanadium of which maximum valence change is divalent.

The method for producing the vanadium solid-salt battery related to the present disclosure includes an active material supporting step of allowing the electrodes constructing the positive electrode and the negative electrode, respectively, to support the active material thereon, the active material containing the vanadium of which oxidation number in the initial state is tetravalent,

wherein in the active material supporting step, the electrodes are allowed to support the active material thereon such that an electrode, of the electrodes, constructing the negative electrode supports the active material containing the vanadium of which maximum valence change in the initial charging is divalent, that an electrode, of the electrodes, constructing the positive electrode supports the active material containing the vanadium of which maximum valence change in the initial charging is monovalent, and that the mole number of the active material including the vanadium of which maximum valence change is monovalent is not less than 1.5 times the mole number of the active material including the vanadium of which maximum valence change is divalent.

The method for producing the vanadium solid-salt battery related to the present disclosure includes an active material supporting step of allowing the electrodes constructing the positive electrode and the negative electrode, respectively, to support the active material thereon, the active material containing the vanadium of which oxidation number in the initial state is trivalent,

wherein in the active material supporting step, the electrodes are allowed to support the active material thereon such that an electrode, of the electrodes, constructing the positive electrode supports the active material containing the vanadium of which maximum valence change in the initial charging is divalent, that an electrode, of the electrodes, constructing the negative electrode supports the active material containing the vanadium of which maximum valence change in the initial charging is monovalent, and that the mole number of the active material including the vanadium of which maximum valence change is monovalent is not less than 1.5 times the mole number of the active material including the vanadium of which maximum valence change is divalent.

What is claimed is:

1. A vanadium solid-salt battery comprising:
a positive electrode and a negative electrode each containing vanadium of which oxidation number in an initial state is trivalent or tetravalent; and
a separator which separates the positive electrode from the negative electrode and which allows hydrogen ions to pass therethrough,
wherein maximum valence change in initial charging of the vanadium contained in one of the positive and negative electrodes is divalent, and maximum valence change in the initial charging of the vanadium contained in the other of the positive and negative electrodes is monovalent; and
mole number of the vanadium of which maximum valence change is monovalent is not less than 1.5 times mole number of the vanadium of which maximum valence change is divalent.

2. The vanadium solid-salt battery according to claim 1, wherein each of the positive and negative electrodes contains the vanadium of which oxidation number in the initial state is tetravalent;
the maximum valence change in the initial charging of the vanadium contained in the positive electrode is monovalent; and
the maximum valence change in the initial charging of the vanadium contained in the negative electrode is divalent.

3. The vanadium solid-salt battery according to claim 1, wherein each of the positive and negative electrodes contains the vanadium of which oxidation number in the initial state is trivalent;
the maximum valence change in the initial charging of the vanadium contained in the positive electrode is divalent; and
the maximum valence change in the initial charging of the vanadium contained in the negative electrode is monovalent.

4. A method for producing a vanadium solid-salt battery comprising:
supporting a first active material on one of electrodes constructing a positive electrode and a negative electrode, the first active material containing vanadium of which oxidation number in an initial state is trivalent or tetravalent and of which maximum valence change in initial charging is monovalent, and
supporting a second active material on the other of the electrodes constructing the positive electrode and the negative electrode, the second active material containing vanadium of which oxidation number in an initial state is trivalent or tetravalent and of which maximum valence change in the initial charging is divalent, wherein
mole number of the first active material is not less than 1.5 times mole number of the second active material.

5. The method for producing the vanadium solid-salt battery according to claim 4, wherein
oxidation number in the initial state of the vanadium contained in each of the first and second active materials is tetravalent,
the first active material is supported on an electrode constructing the positive electrode, and
the second active material is supported on an electrode constructing the negative electrode.

6. The method for producing the vanadium solid-salt battery according to claim 4, wherein
oxidation number in the initial state of the vanadium contained in each of the first and second active materials is trivalent,
the first active material is supported on an electrode constructing the negative electrode,
the second active material is supported on an electrode constructing the positive electrode.
